(19) United States
(12) Patent Application Publication
(10) Pub. No.: US 2008/0080502 A1
(43) Pub. Date: Apr. 3, 2008

(54) Methods, devices, and computer program products for providing urgent communications

(76) Inventors: Scott Frank, Dunwoody, GA (US); Robert Koch, Norcross, GA (US)

Correspondence Address: CANTOR COLBURN LLP - BELLSOUTH, 20 Church Street, 22nd Floor, Hartford, CT, 06103, US

(21) Appl. No.: 11/529,106

(22) Filed: Sep. 28, 2006

(51) Int. Cl. H04L 12/56

(52) U.S. Cl. 370/392; 370/252

(57) ABSTRACT

A method of processing a received communication at a recipient communication device includes receiving the communication and determining if the communication is designated urgent. If the communication is urgent, at least one parameter of the recipient communication device is altered in response to urgent information accompanying the urgent communication. Receipt of the urgent communication is signaled at the recipient communication device.

### CROSS REFERENCE TO RELATED APPLICATIONS

This application is related to commonly assigned U.S. patent application Ser. No. 10/899,617, filed Jul. 27, 2004, now published as US 2006/0026277, U.S. patent application Ser. No. 10/303,416, filed Nov. 25, 2002, and U.S. patent application Ser. No. 11/181,321, filed Jul. 14, 2005, now published as US 2006/0003758. The entire contents of these documents are incorporated herein by reference

### BACKGROUND

Exemplary embodiments relate generally to communication services and, more particularly, to methods, systems, and computer program products for providing urgent communications.

There are situations when a sender of a communication wishes to indicate that the communication being sent is urgent. Such situations include, for example, an emergency situation where prompt reply is needed.

There exist systems for providing alerts to a communication device. In such systems, typically, a sender of a communication has little or no ability to indicate that the communication is urgent and requires immediate attention and/or response from the recipient. In e-mail systems, the sender may designate a sent e-mail as high priority. In such systems, however, if the recipient e-mail program is not active, the recipient does not observe the urgent communication. There is a need in the art for a system for sending urgent communications that alter operating parameters of a recipient device to facilitate observance by the recipient.

### BRIEF SUMMARY

Exemplary embodiments relate to methods of processing a received communication at a recipient communication device including receiving the communication and determining if the communication is designated urgent. If the communication is urgent, at least one parameter of the recipient communication device is altered in response to urgent information accompanying the urgent communication. Receipt of the urgent communication is signaled at the recipient communication device.

Additional exemplary embodiments include computer program products comprising a storage medium readable by a processing circuit and storing instructions for execution by the processing circuit for facilitating the methods of processing a received communication at a recipient communication device.

Further exemplary embodiments include a computer program product for sending an urgent communication, the computer program product comprising a storage medium readable by a processing circuit and storing instructions for execution by the processing circuit for facilitating a method. The method includes generating a communication at a sender communication device and associating an urgent indication and/or urgent information with the communication designating the communication as urgent. The urgent information includes an urgent flag designating the communication as urgent, an optional urgent notification field identifying an urgent notification to be generated at a recipient communication device to indicate receipt of the urgent communication, and an optional urgent communication body field including content to be generated at the recipient communication device.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a block diagram of a system for providing urgent communications in exemplary embodiments;

FIG. 2 is a flowchart of processing communications in exemplary embodiments;

FIG. 3 illustrates urgent information accompanying an urgent communication in exemplary embodiments;

FIG. 4 is a flowchart of processing communications at the recipient device in exemplary embodiments;

FIG. 5 illustrates an exemplary user interface on a sender communications device;

FIG. 6 illustrates an exemplary user interface on a receiver communications device; and

FIG. 7 is a block diagram of a system for providing multiple urgent communications in exemplary embodiments

The detailed description explains the exemplary embodiments, together with advantages and features, by way of example with reference to the drawings.

### DETAILED DESCRIPTION OF EXEMPLARY EMBODIMENTS

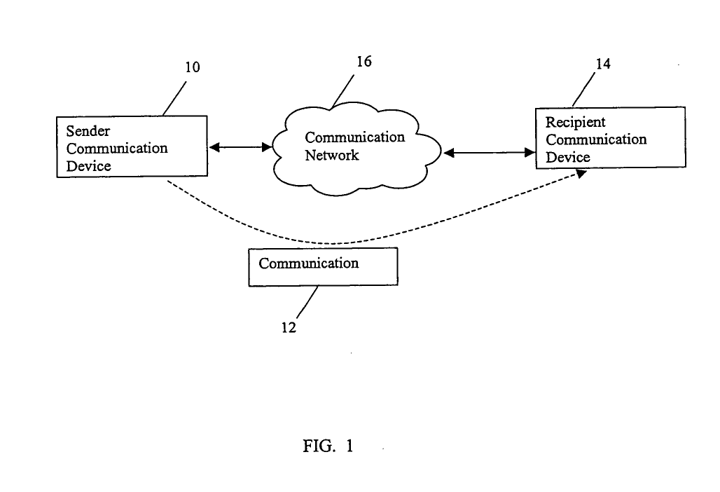

FIG. 1 is a block diagram of a system for providing urgent communications in exemplary embodiments. The sending party, using a sender communications device 10, initiates a communication 12 to a recipient communications device 14 over communication network 16. The sender communications device 10 may be any type of communication device such as a wireless phone, wireline phone, PDA, pager, personal computer, short message service (SMS) device, etc. The recipient communications device 14 may be any type of communication device such as a wireless phone, wireline phone, PDA, pager, personal computer, short message service (SMS) device, etc. Any device including a communication receiver (e.g., television) may serve as the recipient communication device 14.

The communication 12 may be any form of electronic communication, such as an email, Instant Message, short message service (SMS) text, a page, a facsimile, a wireline or wireless telephone call, and/or an Internet Protocol telephone call. The communication 12 is routed from the sender's communications device 10 to the recipient communications device 14 via the communications network 16. Communications equipment (such as computer servers, switches, and other computer systems that will be later explained) operates within the communications network 16 and processes the communication 12. The communication network 16 may comprise any type of network and may comprise a plurality of interconnected networks. These networks include, but are not limited to, Public Switched Telephone Network (PSTN), the Internet, intranet, Public Branch Exchange (PBX), wireless network, satellite network, cable network, power network, and/or a home network.

For ease of illustration, a single communication 12 is shown being sent from sender communication device 10 to the recipient communications device 14. It is understood that similar communications may be sent from device 14 to device 10 and that multiple communications 12 may be sent between devices 10 and 14.

As described in further detail herein, the communication 12 is routed to the recipient communication device 14 and processed in response to the urgency of the communication 12. The sender communication device 10 includes functionality for the sender to specify a level of urgency with respect to the communication 12. The recipient communication device 14 processes the communication in response to the level of urgency.

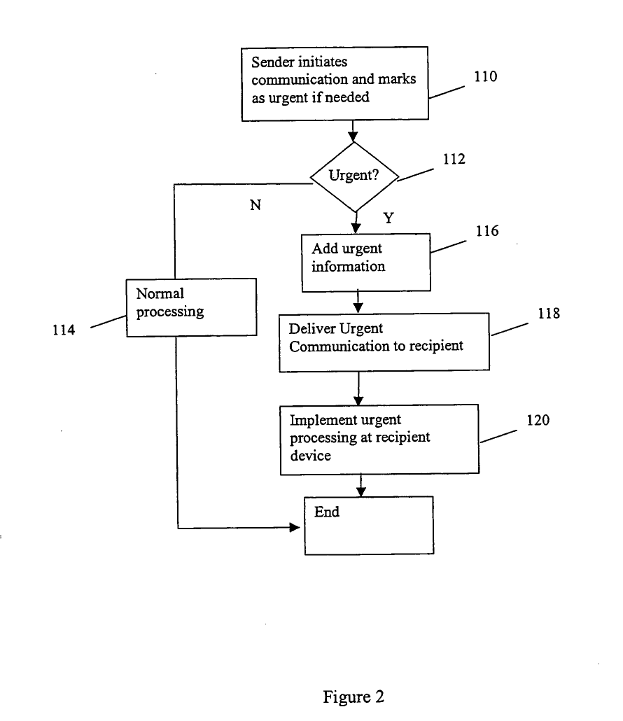

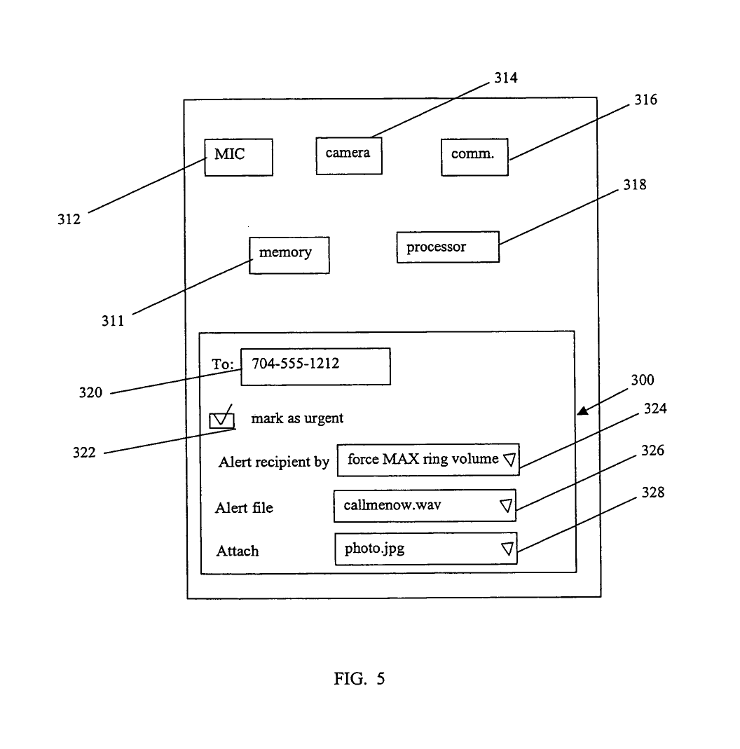

FIG. 2 is a flowchart of processing communications in exemplary embodiments. A process begins at operation 110 where a sender uses sender communication device 10 to initiate communication with the recipient. A software interface within device 10 available to the sender is preferably presented to the user to present the option of marking the communication 12 as urgent and optionally providing additional instructions and/or content to be sent with the communication 12 for processing when the communication 12 is received by the recipient. If the communication 12 is of an urgent nature, the sender selects these offered options accordingly. At operation 112, it is determined if the sender has designated the communication 12 as urgent. According to one embodiment, the sender may designate the communication 12 as urgent by entering an urgent code (e.g., *44) or pressing a key on the sender communication device 10. In alternate embodiments, the sender may designate the communication 12 as urgent by selecting an urgent setting from an interface 300 on the sender communication device 10 as shown in FIG. 5. If the communication 12 is not urgent, flow proceeds to operation 114 where the communication 12 is processed using known techniques.

If at operation 112 the communication 12 has been designated urgent, flow proceeds to operation 116 where urgent information is added to the communication 12. The urgent information may be added at the sender communication device 10, at the communication network 16, or by a combination of processing by these devices 10 and 14.

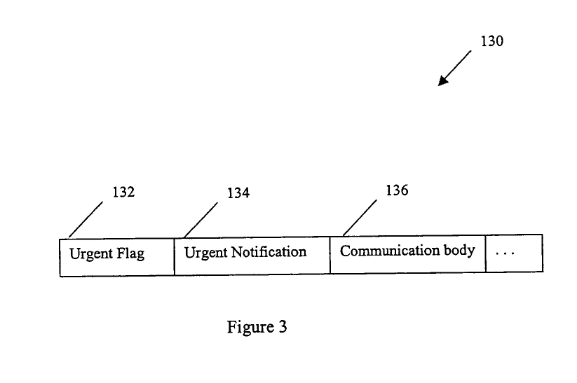

FIG. 3 illustrates urgent information 130 accompanying an urgent communication 12 in exemplary embodiments. The urgent information 130 includes a number of fields including an urgent flag 132. The urgent flag 132 is set if the sender of the communication has designated the communication as urgent. An optional urgent notification field 134 includes any sender specified urgent notification, if applicable. The urgent notification field 134 is used to contain or indicate specific urgent notification structure within device 14 to be invoked when the communication is received by the recipient. The sender may designate a variety of urgent notifications such as an audio file, image, video, text, etc. For example, the sender may specify a recorded audio file as the urgent notification so that when the communication 12 is received at the recipient communication device 14, the urgent notification is played (e.g., “call me immediately”). The urgent notification field 134 may contain content (audio file, image, video, text, etc.) that can be read and presented in an audio/visual manner when the communication is received by the recipient device 14. In such a case, the sender can record the urgent notification content at the time that the communication 12 is initiated and include it immediately with the communication 12 being sent. In an alternate embodiment, the sender may select the urgent notification content from pre-stored urgent notification content within the device 10. As described in further detail herein with reference to FIG. 5, the sender device 10 includes a database in memory 310 that contains optional pre-stored urgent notification content.

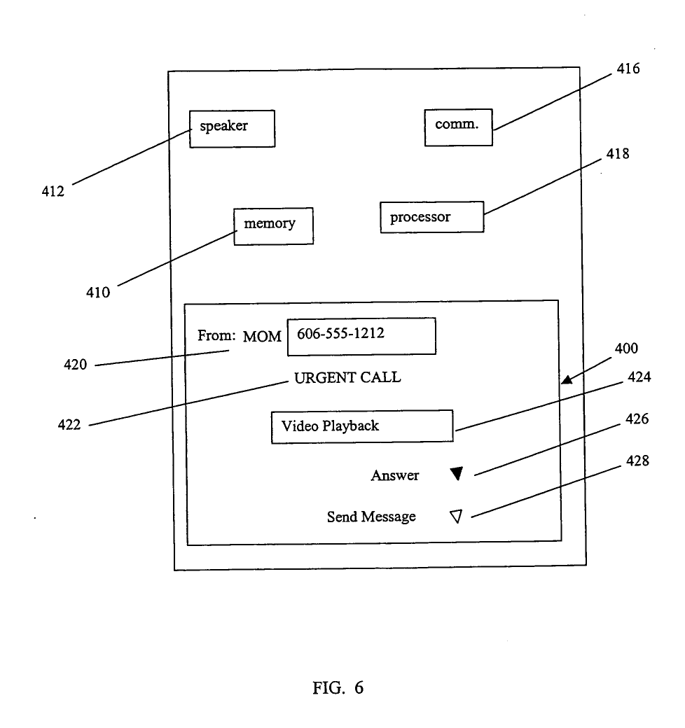

In yet another embodiment, the sender may select an urgent notification indicator that can be interpreted by the recipient device 14 and map to urgent notification content within the device 14. For example, for urgent notification, the sender may select an option from a menu such as “request immediate callback”, which results in a request immediate callback indicator being sent in the urgent notification field 134 which maps to a recipient-specific treatment when the communication is received. As described in further detail herein with reference to FIG. 6, the recipient device 14 includes a database in memory 410 containing pre-stored urgent notification content which is indexed by an indicator. When the sender sends the predefined indicator, the recipient device 14 accesses the pre-stored urgent notification content. If the sender does not specify an urgent notification, then urgent notification field 134 may be empty or assume a default value.

Further, the urgent information 130 includes an urgent communication body field 136. The urgent communication body field 136 optionally includes content of the urgent message, if any. This may include a variety of information such as text, audio, video, etc. The urgent communication body field 136 includes any content that is provided to the recipient communication device 14. This urgent communication body field 136 may include information such as sports scores, weather alerts, a picture of a trophy fish, etc. Therefore, the body of the communication 12 may be comprised of the urgent communication body field 136, in which case the information or file itself is part of the body of the communication 12. In another embodiment, the communication 12 may be a voice-based communication 12 like a telephone call. In this case, the urgent flag 132, urgent notification field 134, and urgent communication body field 136 of FIG. 3 accompany the call attempt information and therefore supplement a 2-way communication session like a conversation that might follow the initial sending and receipt of the information sent in FIG. 3.

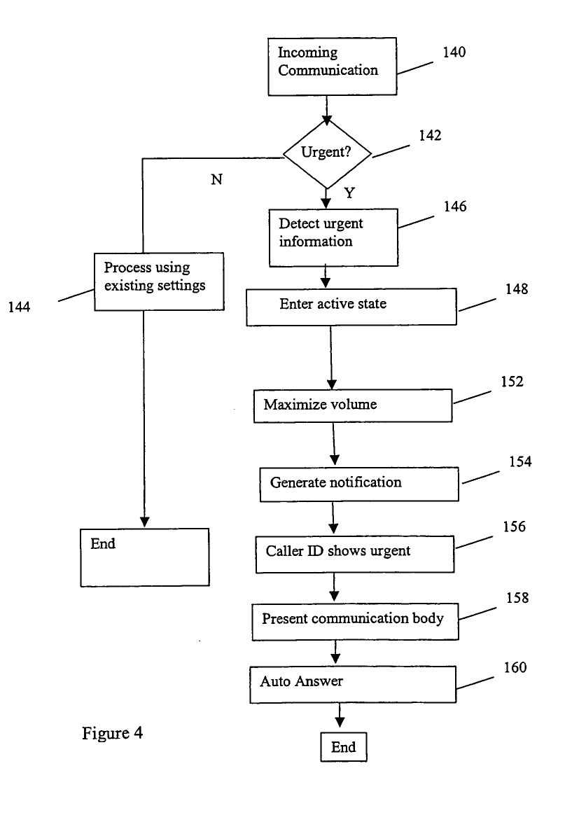

Referring back to FIG. 2, once the urgent information is added to the sender communication 12, flow proceeds to operation 118 where the communication 12 is delivered to the recipient device 14. The recipient device 14 processes the urgent message at operation 120 as described in further detail herein with reference to FIG. 4.

FIG. 4 is a flowchart of processing communications at the recipient communication device 14 in exemplary embodiments. A processor (e.g., microprocessor) in the recipient communications device 14 performs the operations in response to computer program code in the device 14. As shown in FIG. 4 the recipient communication device 14 receives the incoming communication 12 at operation 140. At operation 142, the recipient communication device 14 determines if the communication 12 is urgent or not. According to an exemplary embodiment, the recipient device 14 performs this operation by detecting the value of the urgent flag field 132 in the communication 12. If the communication 12 is not urgent, then the recipient device 14 processes the communication 12 using the existing settings on the recipient communication device 14 as shown at operation 144.

If at operation 142, the recipient device 14 determines that the communication 12 is urgent, then flow proceeds to operation 146 where the recipient device 14 detects the urgent information 130. This may include the recipient device 14 extracting the urgent notification from field 134 (if present) and the urgent communication body field 136 (if any). As described above, the urgent notification field 134 may include a predefined indicator that maps to pre-stored urgent notification files stored in a database 410 in the recipient device 14. At operation 146, the predefined indicator, if any, is extracted from the urgent notification field 134.

Once the urgent information is obtained by the recipient device 14, flow proceeds to operation 148 where the recipient communication device's state may be altered from a standby state to an active state if the device 14 was in a standby state. Once powered in an active state, the recipient communication device 14 may alter another parameter in response to the urgent information 130. For example, the recipient communication device 14 may increase the volume (e.g. to a maximum setting) at operation 152. Other parameters of the recipient communication device 14 may be altered such as screen brightness, vibration intensity, or any other software-changeable characteristics of the device 14.

At operation 154, the recipient communication device 14 generates the urgent communication notification. The notification may be a standard urgent notification stored in the recipient communication device 14. Alternatively, the urgent notification may be extracted by the recipient device 14 from field 134 and played on the recipient communication device 14. If an urgent notification is provided in field 134, this urgent notification overrides the standard notification set in recipient communication device 14. Further, the urgent notification field 134 may include a predefined indicator that indexes one of multiple stored urgent notifications in memory 410 (FIG. 6).

At operation 156, the recipient device 14 may display on its caller ID, if enabled, the word URGENT or a similar indicator that the communication 12 is urgent. Again, the recipient communication device 14 may alter the standard caller ID processing or otherwise invoke special visual, audio, and/or mechanical (e.g., vibrational) characteristics, in response to detecting the urgent communication flag 132. The existing settings on the recipient device (e.g., vibration notification) is overridden by urgent notification field 134 and the urgent communication body field 136. For example, the vibration notification setting on the recipient device may be overridden to a tone based notification identified in the urgent notification field 134. Similarly, the standard ring tones may be altered to a ring tone specified in the urgent notification field 134. Additional details on how the sender specifies the urgent communication flag 132, urgent notification field 134, urgent communication body field 136 are described herein with reference to FIG. 5.

At operation 158, the recipient device 14 presents content from the urgent communication body field 136, if any. This content may be an audio content, image content, text content, video content etc. At operation 160, the recipient communication device 14 may enter an auto-answer mode to automatically place the sender and the recipient in communication. For example, if the sender is placing an urgent voice call, the recipient communication device 14 may go off hook in operation 160 to immediately put the recipient in communication with the sender without the recipient having to take any action.

With respect to the actions in operations 152, 154, 156, 158, and 160, it is understood that the recipient communication device 14 may be configured by the recipient to perform all, some or none of these actions. Thus, embodiments of the invention allow the recipient to configure the recipient communication device 14 as desired.

FIG. 5 illustrates an exemplary user interface on a sender communications device 10 and components of the sender communications device 10. The sender communications device 10 may include a memory 311, a communications module 316 and a processor 318. The sender communication device 10 may also include a user interface 300, a microphone 312, and a camera 314, or any combination thereof. The processor 318 may be a general-purpose microprocessor executing computer program code contained in memory to implement the functions described herein. The communications module 316 handles the sending and receiving of communications using existing protocols (e.g., wireline, wireless, VoIP). The microphone 312 and camera 314 operate in conventional manners, and may be used to generate content to be stored in memory 311.

The user interface 300 provided on the sender communications device 10 may allow the user to implement a number of functions related to urgent communications. User interface 300 may include a display screen and keys (not shown) through which the user interacts with the sender communication device 10. An address field 320 allows the user to select a recipient for the communication. The address field 320 may be completed manually by entering alpha-numeric characters (e.g., phone numbers, email addresses) or may be populated from an address book stored on sender communications device 10. An urgent field 322 may be used to designate the communication as urgent. Selection of the urgent field sets the urgent communication flag 132.

An urgent notification menu 324 allows the sender to select one or more urgent notification actions through, for example, a drop down menu. The sender may select items such as force maximum ring volume, force vibrate notification, show urgent on caller ID, wake up recipient device, etc. These urgent notification actions may be enabled or disabled by the sender one at a time, or a group of urgent notification actions may be set as a default. The urgent notification actions selected from menu 324 are used to populate urgent notification field 134.

The sender may also specify a particular notification to be generated at the recipient device 14 to indicate an urgent communication. A notification menu 326 allows the user to specify an urgent notification file, which is communicated in urgent notification field 134. The sender has multiple options in defining the urgent notification. The sender may select a file stored in memory 311 in sender device 12 as the notification. The notification menu 326 may include an option to allow the user to create a notification file by recording audio and/or video through the microphone 312 and/or camera 314. Alternatively, the sender may send a notification file indicator that indexes a notification file on the recipient device. As described in further detail herein, the recipient device 14 may receive the notification file indicator and retrieves a notification file indexed by the notification file indicator from local memory.

An attachment menu 328 allows the sender to specify the content to be used in the urgent communication body field 136. The sender has multiple options in defining the content for urgent communication body. The sender may select content stored in memory 311 in sender device 12 as the urgent communication body. The attachment menu 328 may include an option to allow the user to create content for the urgent communication body by recording audio and/or video through the microphone 312 and/or camera 314. As described above, the content designated in the urgent communication body field 136 is transmitted to the recipient device 14 and presented to the recipient.

FIG. 6 illustrates an exemplary user interface on a recipient communications device 10 and components of the recipient communications device 10. It is understood that both the sender and recipient communication devices may include similar components so as to both send/receive communications. For ease of illustration, only a subset of all components is depicted.

The recipient communications device 14 may include a speaker 412, memory 410, a communications module 416 and a processor 418. The processor 418 may be a general-purpose microprocessor executing computer program code contained in memory to implement the functions described herein. The communications module 416 handles the sending and receiving of communications using existing protocols (wireline, wireless, VoIP). The speaker 412 presents audio content to the user. Memory 410 stores a variety of elements, including a database of urgent notification files indexed by notification indicators.

The communications module 416 receives a communication from the sender device 10 and parses the urgent information 130 for processor 418. When the processor 418 detects the urgent notification flag 132, processor 418 executes processing as shown in FIG. 4. An urgent notification is extracted from the urgent notification field 134, if any. When the urgent notification field 134 includes a notification indicator, processor 418 detects the notification indicator and retrieves the corresponding notification file from memory 410 for presentation to the user. If the urgent notification field 134 is empty, then a default urgent notification file may be utilized.

A user interface 400 may be provided on the recipient communications device 14 that allows the user to be notified of urgent communications. User interface 400 may include a display screen and keys (not shown) through which the user interacts with the recipient communication device 14. When an urgent communication is received, a sender indicator 420 may be displayed on the user interface. Further, an urgent indicator 422 may be presented on the user interface 400. Processor 418 also initiates presentation of an urgent notification (either default or specified by the sender). The urgent notification may include audio presented via speakers 412 and/or video presented via display 424. If the urgent communication includes an urgent communication body, this content is also presented via speakers 412 and/or user interface display 424, as appropriate.

The recipient device 14 may also provide the recipient with an option to reply to the urgent communication 12 without connecting a call with the sender as described in U.S. application publication 20060098792, the contents of which are incorporated herein by reference. In exemplary embodiments, two options are displayed on user interface 400, “Answer” and “Send Message.” In situations where the recipient is unable or unwilling to answer the urgent communication 12, the “Send Message” option allows the recipient to acknowledge the urgent communication 12 without connecting with the sending party. Other options and methods for responding in this manner are described more fully in U.S. application publication 20060098792. If the recipient ignores the communication attempt, i.e., takes no action, the call proceeds to a voicemail system of the recipient. Likewise, if the recipient selects the “Send Message” option, the urgent communication 12 may proceed to a voicemail system even though the recipient responds with an acknowledgement message. Upon selecting the “Send Message” option, the recipient device 14 initiates a data request for an acknowledgement message and is used by an automated call acknowledgement service to generate an acknowledgement message back to the sender communications device 10.

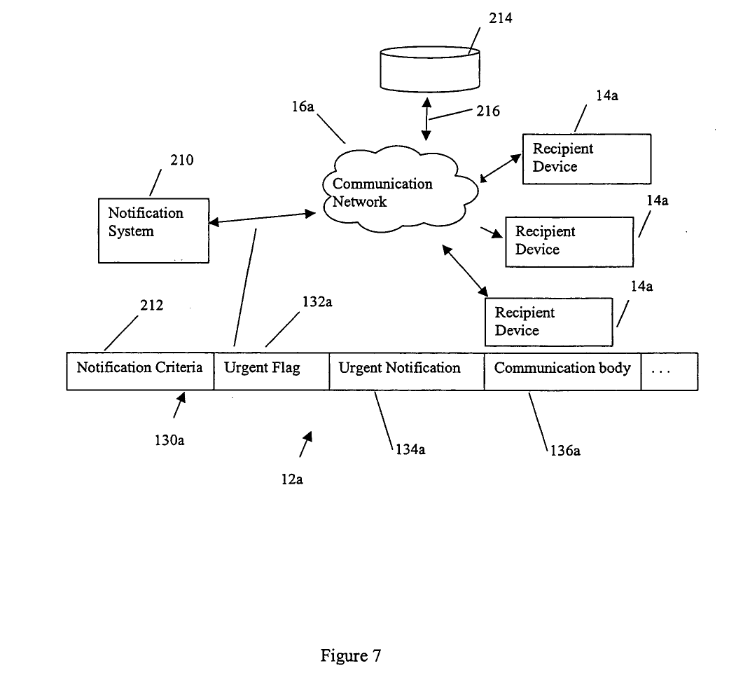

In the above embodiments, the sender communication device 10 sends the urgent communication 12 to a recipient device 14. In alternate embodiments, the sender communication device 10 may be a notification system that distributes urgent communications 12 to multiple recipient communication devices 14. FIG. 7 is a block diagram of a system in exemplary embodiments. A notification system 210 generates urgent communications 12a that may be based on public emergency (e.g., weather alerts) or breaking events. The notification system 210 generates the urgent communication 12a using urgent information 130a, which includes the urgent information 130 described above with reference to FIG. 3, along with notification criteria 212. Thus, urgent notification information 130a may include an urgent flag 132a, urgent notification field 134a and urgent communication body field 136a which may be similar to flag 132, field 134 and field 136, respectively. The notification criteria 212 may include a variety of metrics by which recipients of the notification are identified. For example, the notification criteria 212 may specify that all recipients in a geographic area receive the urgent communication 12a. This may be used, for example, in the event of an urgent weather notification.

A communication network 16a may maintain a database 214 of recipients based on certain classification criteria, such as geographical area, based on, for example, registration messages received at cell locations of recipients entering a cellular area. Alternatively, the notification criteria 212 may specify a certain area code or other criteria associated with recipients intended to receive the urgent communication 12a. For example, recipients having an 860 area code would be designated to receive urgent communications 12a related to the Hartford, Conn. region. In this example, the database 214 may include information indicating recipients with various area codes. In alternate embodiments, the notification criteria 212 specify a group of recipients who have registered for the urgent notification service. For example, the notification criteria 212 may designate subscribers to a news service that provides breaking news updates. In this example, the list of recipients who have registered is stored in the database 214. The list of recipients who are to be notified may be stored elsewhere, e.g., at the notification system 210.

The communication network 16a, which may be similar to the network 16 shown in FIG. 1, may detect urgent flag 132a, extract the notification criteria 212 from the communication, determine the recipients to receive the urgent communication and index the necessary communication paths from database 214. The communications network 16a may include communications network elements (switches, routers, databases, etc.) including processors that perform these functions in response to computer program code. The communications network 16a may access the database 214 over a link 216. Link 216 may be part of the communications network 16a interconnecting network elements or a communications path external to the communications network 16a.

The database 214 may include user phone numbers, user IP addresses, etc. retrieved from the database 214 based on the notification criteria 212. The communications network 16a then distributes the urgent communication to the recipient communication devices 14a of the recipients determined by the notification system 210 to receive the urgent communications 12a. The recipient communication devices 14a, which may be similar to devices 14 shown in FIG. 1, may process the urgent communications 12a as described above with reference to FIG. 4.

As described heretofore, the exemplary embodiments can be provided in the form of computer-implemented processes and apparatuses for practicing those processes. The exemplary embodiments can also be provided in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be provided in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method of processing a received communication, the method comprising:
receiving the communication;
determining if the communication is designated urgent;
if the communication is urgent;
altering at least one parameter of a recipient communication device in response to urgent information accompanying the urgent communication; and
signaling receipt of the urgent communication at the recipient communication device.

2. The method of claim 1 wherein determining if the communication is urgent includes detecting the state of an urgent flag associated with the communication.

3. The method of claim 1 wherein altering at least one parameter of the recipient communication device includes powering on the recipient communication device.

4. The method of claim 1 wherein altering at least one parameter of the recipient communication device includes increasing the volume of the notification of the recipient communication device.

5. The method of claim 1 wherein signaling receipt of the urgent communication includes extracting an urgent notification from the urgent information and using the urgent notification to signal receipt of the urgent communication.

6. The method of claim 1 wherein signaling receipt of the urgent communication includes extracting an urgent notification from the recipient communication device and using the urgent notification to signal receipt of the urgent communication.

7. The method of claim 1 wherein signaling receipt of the urgent communication includes altering the caller identification on the recipient communication device.

8. The method of claim 1 further comprising extracting content from an urgent communication body field of the urgent information and providing the content on the recipient communication device.

9. The method of claim 1 wherein altering at least one parameter of the recipient communication device includes automatically answering the urgent communication at the recipient communication device.

10. The method of claim 1 wherein signaling receipt of the urgent communication includes presenting the contents of an audio file.

11. A computer program product for processing a received communication at a recipient communication device, the computer program product comprising instructions for:
receiving the communication;
determining if the communication is designated urgent;
if the communication is urgent;
altering at least one parameter of the recipient communication device in response to urgent information accompanying the urgent communication;
signaling receipt of the urgent communication at the recipient communication device.

12. The computer program product of claim 11 wherein determining if the communication is urgent includes detecting the state of an urgent flag associated with the communication.

13. The computer program product of claim 11 wherein altering at least one parameter of the recipient communication device includes powering on the recipient communication device.

14. The computer program product of claim 11 wherein altering at least one parameter of the recipient communication device includes increasing the volume of the notification of the recipient communication device.

15. The computer program product of claim 11 wherein signaling receipt of the urgent communication includes extracting an urgent notification from the urgent information and using the urgent notification to signal receipt of the urgent communication.

16. The computer program product of claim 11 wherein signaling receipt of the urgent communication includes extracting an urgent notification from the recipient communication device and using the urgent notification to signal receipt of the urgent communication.

17. The computer program product of claim 11 wherein signaling receipt of the urgent communication includes altering the caller identification on the recipient communication device.

18. The computer program product of claim 11 further comprising extracting content from an urgent communication body field of the urgent information and providing the content on the recipient communication device.

19. The computer program product of claim 11 wherein altering at least one parameter of the recipient communication device includes automatically answering the urgent communication at the recipient communication device.

20. A computer program product for sending an urgent communication, the computer program product comprising instructions for:
generating a communication at a sender communication device;
associating urgent information with the communication;
wherein the urgent information includes an indictor designating the communication as urgent and associated instructions to be sent with the communication to a recipient of the communication to instruct a recipient device of the communication to alter at least one communication alerting characteristic in response to receipt of the instructions.

21. The computer program product of claim 20 wherein the urgent information further includes an urgent flag designating the communication as urgent.

22. The computer program product of claim 21 wherein the urgent information further includes an urgent notification field identifying an urgent notification to be generated at a recipient communication device to indicate receipt of the urgent communication.

23. The computer program product of claim 22 wherein the urgent information further includes an urgent communication body field including content to be generated at the recipient communication device.
